(19) United States
(12) Patent Application Publication
(10) Pub. No.: US 2015/0174952 A1
(43) Pub. Date: Jun. 25, 2015

(54) Baby Stroller Wheel Covers

(71) Applicant: Denise Ruggio, Whitestone, NY (US)

(72) Inventor: Denise Ruggio, Whitestone, NY (US)

(73) Assignee: Denise Ruggio

(21) Appl. No.: 14/135,652

(22) Filed: Dec. 20, 2013

(51) Int. Cl. B60B 7/02

(52) U.S. Cl. CPC B60B 7/02; B60Y 2200/83; B60B 2900/211

(57) ABSTRACT

A removable cover for baby stroller wheels. The cover is used as a means to protect flooring from dirt and to protect humans from contamination of germs transferred from an exposed stroller wheel to flooring. The cover is constructed from waterproof material and encases elastic sides with a hook and loop fastening system in 3 positions. The cover is constructed for baby stroller wheels specifically because of its ability to be adjustable to fit multiple sized wheels and various models of baby strollers. The cover is fastened over the wheel front to back and fastened in the optimal position on the loop fastener allowing the stroller and its wheels to roll with the cover in place. Wheel cover is machine washable to maintain cleanliness.

### BACKGROUND OF THE INVENTION

The present invention relates to a covering device and, more particularly, to a wheel covering device.

Currently, when taking a baby stroller or wheel chair inside, the wheels may be dirty due to use. The dirt from the wheels may then rub onto the floor. This may cause the interior floor to become dirty and one may have to clean the floor or the wheels.

As can be seen, there is a need for a cover for the wheels.

### BRIEF DESCRIPTION OF THE DRAWINGS

FIG. 1 is a perspective view of an embodiment of the invention;

FIG. 2 is a perspective view of an embodiment of the invention; and

FIG. 3 is the embodiment of FIGS. 1 and 2 in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may surround a wheel of a baby stroller or wheel chair with a waterproof and machine washable material. The material thus creates a barrier from the dirt on the wheels and a floor. In certain embodiments, the wheel cover may be adjustable for different sized wheels. Further, the present invention may be placed around the wheel's circumference so that the cover may accommodate a swivel wheel with a center axle. The present invention may be constructed in multiple different sizes to accommodate small and larger wheels. For example, even though the item may be adjustable to fit varying sized wheels, when manufactured; the present invention may be made in sizes small, medium and large for a more exact fit to the many different strollers and wheelchair sizes on the current market.

Broadly, an embodiment of the present invention provides a wheel covering device comprising: a main covering comprising a strip of material having a first end and a second end; an attachment device attached to the first end and the second end, wherein the attachment device attaches the first end and the second end together.

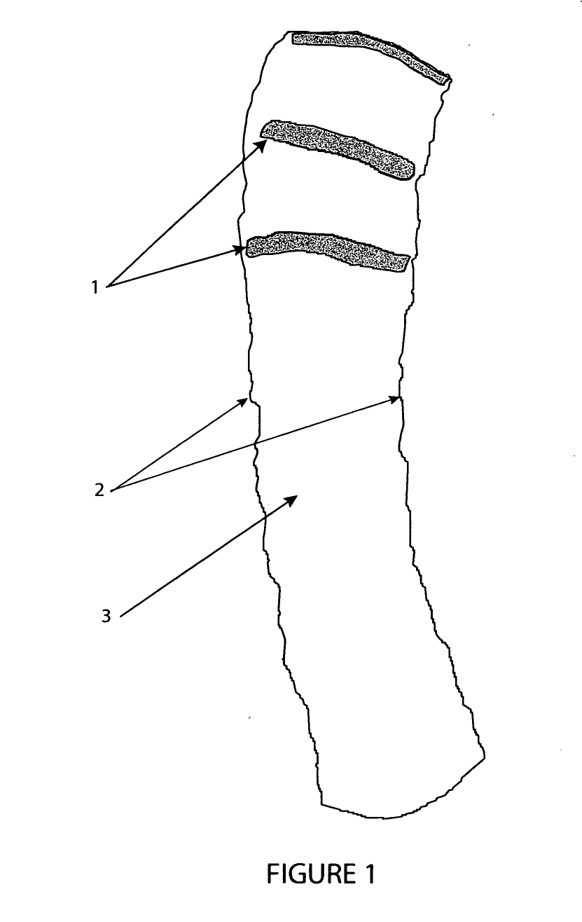

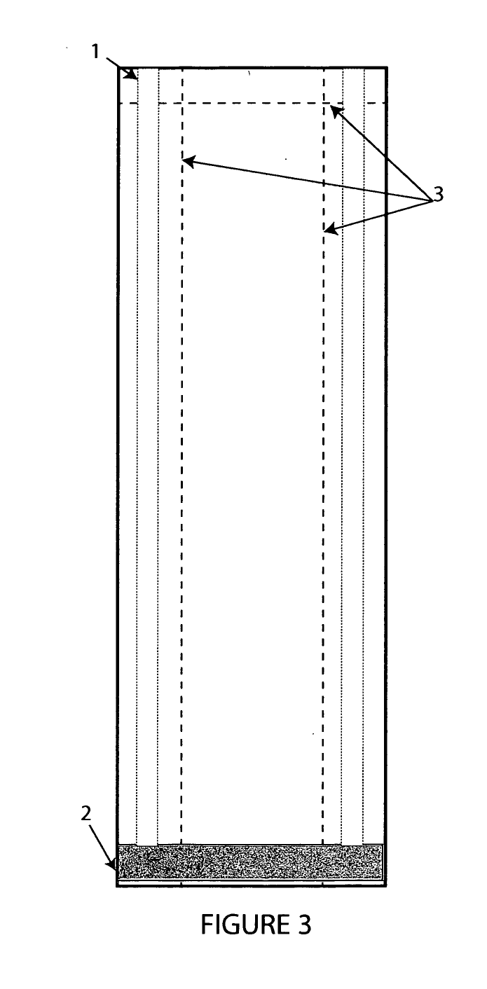

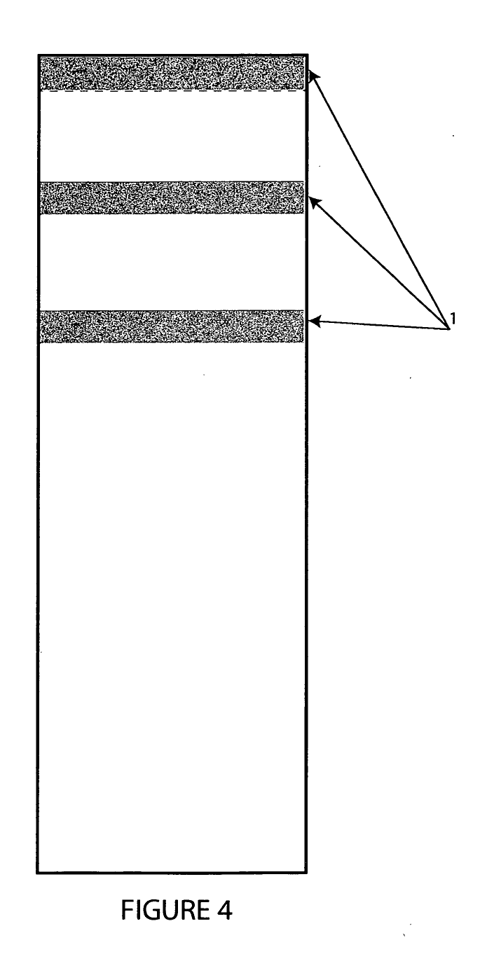

Referring now to FIGS. 1 through 3, the present invention may include a main covering 10, elastic 12 and an attachment device 18. The main covering 10 may be an encasement that covers the wheel 20 of the stroller or wheel chair. In certain embodiments, the main covering 10 may be made of a waterproof, machine washable material. For example, the main covering 10 may be made of nylon. The main covering 10 may be wrapped around the wheel 20 of stroller or wheel chair.

The main covering 10 may be lined with an elastic material 12. In certain embodiments, the elastic material 12 may be attached to the sides of the main covering 10. However, it is envisioned that the elastic material 12 may be attached throughout the main covering 10. The elastic material 12 may be used to help keep the main covering 10 snug to the wheel 20. Therefore, the elastic material 12 may aid in keeping the main covering 10 on the wheel 20.

In certain embodiments, the main covering 10 may further include an attachment device 18. The attachment device 18 may be an adjustable attachment device. The attachment device 18 may secure one end of the main covering 10 to the other end of the main covering 10, and thereby secure the main covering 10 onto the wheel.

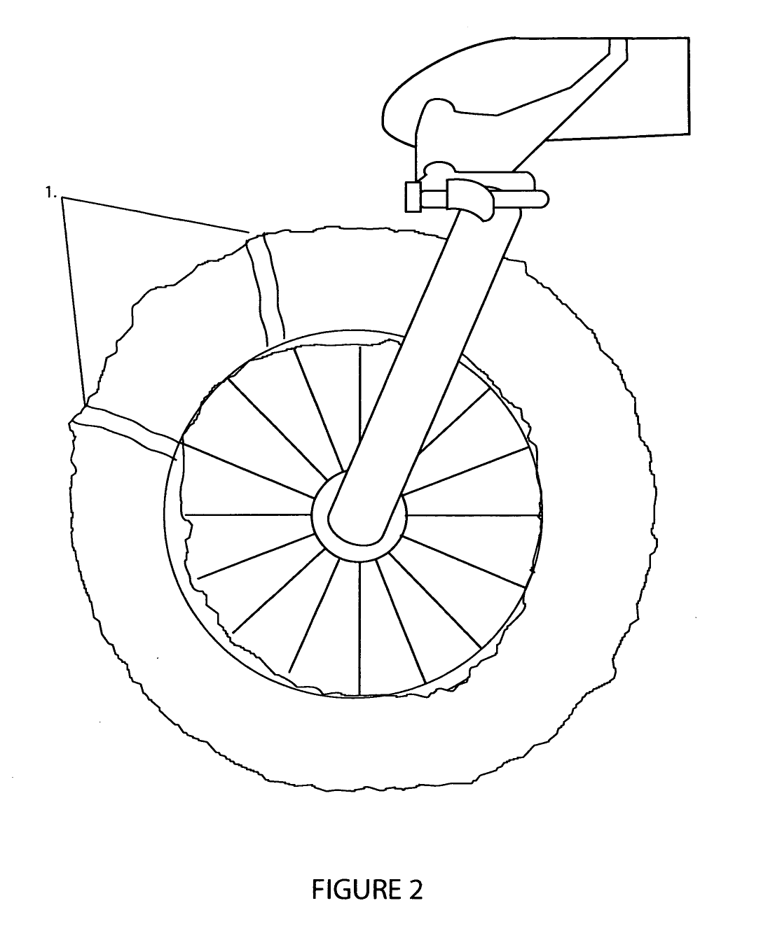

In certain embodiments, the attachment device 18 may include a hook and loop fastener, a clip fastener with an adjustable strap and the like. The hook and loop fastener may include a loop fastener 14 at one end of the main covering 10 and a hook fastener 16 located on the opposite end and side of the main covering. In certain embodiments, the loop fastener 14 may be on an outer side of the main covering and the hook fastener 16 may be on an inner side of the main covering. There may be multiple strips of hook and loop fastener to secure different sized wheels. As illustrated in FIGS. 1 and 2, there may be three strips of loop fastener 14.

A method of using the device may include the following. A user may lay the main covering 10 on the floor, roll the wheel 20 over the main covering 10 and to its center. The user may then wrap the cover 10 around the circumference of the wheel. The user may then attach the two ends of the cover 10 by the attachment device 18, such as the hook and loop fastener.

A method of making the device may include the following. A person may make the present invention by sewing two strips of elastic vertically down the edges of a rectangular piece of waterproof material within a casing in which the edges of the material may be folded inward with the elastic inside for the purpose of strengthening the device. The person may sew the hook part of the fastener to the top inside part of the rectangle material. The person may then sew three pieces of the loop part of the fastener to the outside in three positions, side by side.

It should be understood, of course, that the foregoing relates to exemplary embodiments of the invention and that modifications may be made without departing from the spirit and scope of the invention as set forth in the following claims.

What is claimed is:

1. A wheel covering device comprising:
a main covering comprising a strip of material having a first end and a second end;
an attachment device attached to the first end and the second end, wherein the attachment device attaches the first end and the second end together.
